(19) United States
(12) Patent Application Publication
(10) Pub. No.: US 2021/0346990 A1
(43) Pub. Date: Nov. 11, 2021

(54) WORKPIECE PROCESSING METHOD

(71) Applicant: DISCO CORPORATION, Tokyo (JP)

(72) Inventors: Jinyan ZHAO, Tokyo (JP); Shigenori HARADA, Tokyo (JP); Takashi OKAMURA, Tokyo (JP)

(21) Appl. No.: 17/233,657

(22) Filed: Apr. 19, 2021

(30) Foreign Application Priority Data
May 7, 2020 (JP) 2020-082138

(51) Int. Cl. B23K 26/36; B23K 26/18; B23K 26/146; B23K 26/08; B23K 26/142

(52) U.S. Cl. CPC B23K 26/36; B23K 26/18; B23K 2101/40; B23K 26/0823; B23K 26/142; B23K 26/146

(57) ABSTRACT

A workpiece processing method includes a protective film forming step of coating an upper surface of a wafer with a protective film including a water-soluble resin, a laser processing step of applying a laser beam of such a wavelength as to be absorbed in the wafer to the upper surface to subject the wafer to ablation, and a cleaning step of removing the protective film from the upper surface of the wafer together with debris generated in the laser processing step. The cleaning step includes a first cleaning sub-step of spinning a spinner table holding the wafer and supplying a cleaning fluid to the upper surface of the wafer and a second cleaning sub-step of supplying a mixed fluid of gas and the cleaning fluid to the upper surface of the wafer held by the spinning spinner table, to clean the wafer.

### BACKGROUND OF THE INVENTION

### Field of the Invention

The present invention relates to a workpiece processing method that includes a cleaning step.

### Description of the Related Art

Heretofore, ablation by a laser processing apparatus has been known, as, for example, disclosed in Japanese Patent Laid-open No. 2004-322168. In Japanese Patent Laid-open No. 2004-322168, in order to prevent debris generated upon ablation from adhering to apparatuses, a front surface of the workpiece is preliminarily covered with a protective film including a water-soluble resin, prior to the ablation. After the ablation, the workpiece is washed with a cleaning fluid, whereby the protective film is removed from the workpiece together with the debris adhered to the protective film.

In Japanese Patent Laid-open No. 2004-322168, a device configuration capable of formation of the protective film and removal of the protective film by cleaning is disclosed. Such a device is called a protective film applying and cleaning device or a spin coater. A specific device configuration includes a spinner table, resin liquid supplying means, and cleaning water supplying means.

### SUMMARY OF THE INVENTION

Conventionally, a mixed fluid including gas and liquid is used as the cleaning fluid for the workpiece, and the mixed fluid is jetted to the workpiece. However, when the mixed fluid containing gas at a high pressure is jetted to the workpiece, the protective film dissolved or peeled off by the mixed fluid may scatter in the protective film applying and cleaning device, and may adhere to the inside of a housing or a nozzle jetting the mixed fluid, or the like; therefore, improvement has keenly been demanded.

Accordingly, it is an object of the present invention to provide a workpiece processing method including a cleaning method by which scattering of a protective film in a protective film applying and cleaning device can be restrained.

In accordance with an aspect of the present invention, there is provided a workpiece processing method including a protective film forming step of coating an upper surface of a workpiece with a protective film including a water-soluble resin, a laser processing step of applying a laser beam of such a wavelength as to be absorbed in the workpiece to the upper surface to subject the workpiece to ablation, after the protective film forming step is carried out, and a cleaning step of removing the protective film from the upper surface of the workpiece together with debris generated in the laser processing step, after the laser processing step is carried out. In the workpiece processing method, the cleaning step includes a holding sub-step of holding the workpiece by a spinner table in a state in which the upper surface of the workpiece coated with the protective film is exposed, a first cleaning sub-step of spinning the spinner table holding the workpiece and supplying a cleaning fluid to the upper surface of the workpiece, and a second cleaning sub-step of supplying a mixed fluid of gas and the cleaning fluid to the upper surface of the workpiece held by the spinning spinner table, to clean the workpiece, after the first cleaning sub-step is carried out.

Preferably, the workpiece processing method further includes a drying step of spinning the spinner table at a speed higher than the spinning of the spinner table in the cleaning step, after the cleaning step is carried out, to thereby dry the workpiece.

According to the present invention, in the first cleaning sub-step, only the cleaning fluid not containing a high-pressure gas is supplied, and the protective film is removed in the manner of being washed away. Thus, the dissolved protective film is restrained from scattering to the surroundings, and the protective film can be prevented from adhering to wall surfaces of an internal space of a housing, each of nozzles, or each of arms. In addition, in the second cleaning sub-step, the protective film does not remain or remains only slightly, since the protective film has preliminarily been removed in the first cleaning sub-step, so that, even when cleaning is conducted with the mixed fluid containing a high-pressure gas, the protective film does not scatter or scatters only slightly.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view depicting a configuration example of a laser processing apparatus;

FIG. 2 is a partially sectional perspective view depicting a configuration example of a protective film applying and cleaning device;

FIG. 3 is a flow chart depicting an example of a processing method;

FIG. 4 is a sectional view depicting a protective film forming step;

FIG. 5 is a partially sectional side view depicting a laser processing step;

FIG. 6 is a sectional view depicting a holding sub-step;

FIG. 7 is a sectional view depicting a first cleaning sub-step;

FIG. 8 is a sectional view depicting a second cleaning sub-step; and

FIG. 9 is a sectional view depicting a drying step.

### DETAILED DESCRIPTION OF THE PREFERRED EMBODIMENT

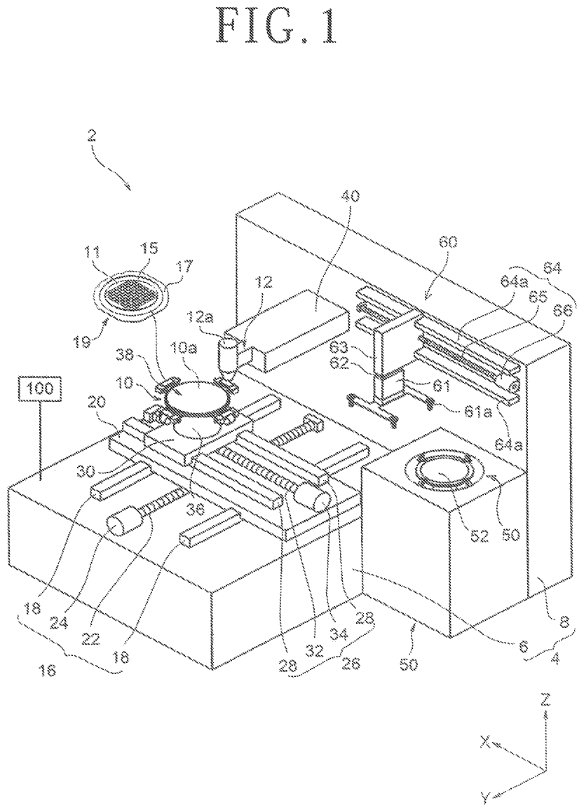

An embodiment of the present invention will be described below referring to the attached drawings. FIG. 1 is a perspective view depicting a configuration example of a laser processing apparatus 2. As illustrated in FIG. 1, the laser processing apparatus 2 includes a base 4 that supports each structure.

The base 4 includes a rectangular parallelepiped base section 6 and a wall section 8 extending upward at a rear end of the base section 6. On an upper surface of the base section 6, a chuck table 10 that suction holds a wafer 11 through a protective tape 15 is disposed.

On a lower side of the chuck table 10, a Y-axis moving unit 16 that moves the chuck table 10 in a Y-axis direction (indexing feeding direction) is provided. The Y-axis moving unit 16 includes a pair of Y-axis guide rails 18 that is fixed on the upper surface of the base section 6 and that is parallel to the Y-axis direction.

On the Y-axis guide rails 18, a Y-axis moving table 20 is slidably disposed. A nut section (not illustrated) is provided on a back side (lower surface side) of the Y-axis moving table 20, and a Y-axis ball screw 22 parallel to the Y-axis guide rails 18 is coupled with the nut section in a rotatable manner.

A Y-axis pulse motor 24 is connected to one end portion of the Y-axis ball screw 22. When the Y-axis ball screw 22 is rotated by the Y-axis pulse motor 24, the Y-axis moving table 20 is moved in the Y-axis direction along the Y-axis guide rails 18.

On a front surface side (upper surface side) of the Y-axis moving table 20, an X-axis moving unit 26 that moves the chuck table 10 in an X-axis direction (processing feeding direction) orthogonal to the Y-axis direction is provided. The X-axis moving unit 26 includes a pair of X-axis guide rails 28 that is fixed to an upper surface of the Y-axis moving table 20 and that is parallel to the X-axis direction.

On the X-axis guide rails 28, an X-axis moving table 30 is slidably disposed. A nut section (not illustrated) is provided on a back surface side (lower surface side) of the X-axis moving table 30, and an X-axis ball screw 32 parallel to the X-axis guide rails 28 is coupled with the nut section in a rotatable manner.

An X-axis pulse motor 34 is connected to one end portion of the X-axis ball screw 32. When the X-axis ball screw 32 is rotated by the X-axis pulse motor 34, the X-axis moving table 30 is moved in the X-axis direction along the X-axis guide rails 28.

On a front surface side (upper surface side) of the X-axis moving table 30, a support base 36 is provided. On an upper portion of the support base 36, the chuck table 10 is disposed. The chuck table 10 is connected to a rotational drive source (not illustrated) provided on a lower side, and is rotated around a Z axis. In the periphery of the chuck table 10, four clamps 38 for clamping and fixing an annular frame 17 supporting the wafer 11, from four sides, are provided.

A front surface of the chuck table 10 is a holding surface 10a that suction holds the wafer 11 through a circular protective tape 15 attached to the wafer 11. On the holding surface 10a, a negative pressure of a suction source (not illustrated) acts through a flow channel (not illustrated) formed inside the chuck table 10, and a suction force for sucking the protective tape 15 is generated.

The wafer 11 is disposed in a central portion of an opening of the annular frame 17 formed of a metal, and the wafer 11 and the frame 17 are fixed to the protective tape 15 through an adhesive or the like. The wafer 11, the protective tape 15, and the frame 17 constitute a wafer unit 19. On the wafer 11 are designed streets in a grid pattern, and, along the streets, laser processing (ablation) is conducted and the wafer 11 is scheduled to be split.

A support arm 40 extending forward is provided at a front surface of an upper portion of the wall section 8, and a processing head 12a of a laser beam applying unit 12 is provided at a tip portion of the support arm 40. The laser beam applying unit 12 includes a laser oscillator not illustrated, and the processing head 12a includes an unillustrated condenser lens that concentrates a laser beam emitted from the laser oscillator to the wafer 11 held by the chuck table 10.

The chuck table 10 is located under the processing head 12a of the laser beam applying unit 12, and ablation of the wafer 11 held by the holding surface 10a is conducted by the laser beam applied from the processing head 12a.

At the front surface of the upper portion of the wall section 8 and on a lateral side of the support arm 40, a conveying device 60 for conveying the wafer unit 19 on the chuck table 10 to a spinner table 52 of a protective film applying and cleaning device 50 is provided.

The conveying device 60 includes a holding arm 61 having a plurality of suction sections 61a for suction holding an upper surface of the frame 17 of the wafer unit 19, a lifting section 62 for lifting the holding arm 61 upward and downward, a horizontal moving section 63 to which the lifting section 62 is connected and which is moved horizontally in the X-axis direction, and an X-axis direction moving mechanism 64 for moving the horizontal moving section 63.

The X-axis direction moving mechanism 64 includes a pair of X-axis guide rails 64a provided in a horizontal direction at the front surface of the wall section 8, an X-axis ball screw 65 disposed between the X-axis guide rails 64a, and an X-axis pulse motor 66 provided at one end of the X-axis ball screw 65.

The X-axis ball screw 65 is inserted in and passed through a nut section (not illustrated) provided in the horizontal moving section 63, and, when the X-axis ball screw 65 is rotated by the X-axis pulse motor 66, the horizontal moving section 63 is moved in the X-axis direction along the X-axis guide rails 64a, and, attendant on this, the holding arm 61 is also moved in the X-axis direction.

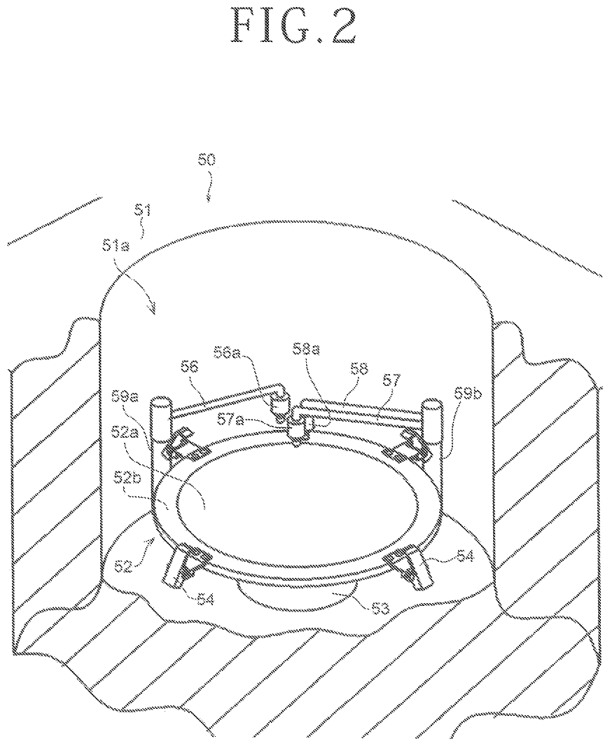

FIG. 2 is a diagram depicting the configuration of the protective film applying and cleaning device 50 (also called a spin coater). The protective film applying and cleaning device 50 includes the spinner table 52 rotationally driven by a motor not illustrated, a support base 53 supporting a lower portion of the spinner table 52 and lifting it upward and downward, clamps 54 that clamp the wafer unit 19 (FIG. 1) held by the spinner table 52, oscillating arms 56 to 58 each oscillated by motors not illustrated, and a housing 51 constituting an internal space 51a surrounding these components.

The spinner table 52 has a suction holding section 52a constituting a flat holding surface and a frame holding section 52b surrounding the periphery of the suction holding section 52a; a part of the wafer 11 of the wafer unit 19 depicted in FIG. 1 is suction held from below by the suction holding section 52a, whereas the frame 17 of the wafer unit 19 is supported by the frame holding section 52b.

As illustrated in FIG. 2, four pendulum-type clamps 54 are provided at the frame holding section 52b of the spinner table 52 and are tilted by a centrifugal force generated by spinning of the spinner table 52, to press from above and clamp the frame 17 (FIG. 1).

The oscillating arms 56 to 58 are provided to be oscillated in horizontal directions on an upper side of the spinner table 52, a protective film resin supplying nozzle 56a is provided at a tip section of one oscillating arm 56 thereof, and a water-soluble resin is supplied downward from the protective film resin supplying nozzle 56a. The water-soluble resin is a material for forming the protective film and is, for example, polyvinyl alcohol (PVA), polyethylene glycol (PEG), polyethylene oxide (PEO), polyvinyl pyrrolidone (PVP), or the like.

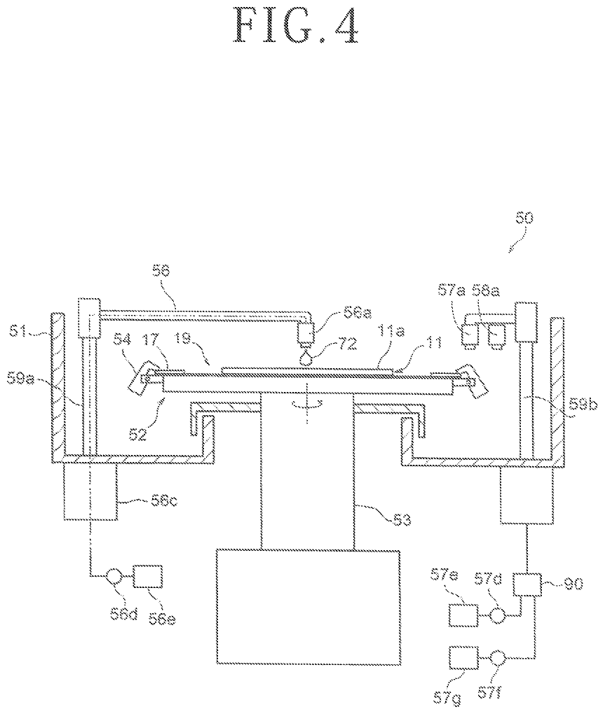

As depicted in FIG. 4, the protective film resin supplying nozzle 56a is connected to a water-soluble resin supply source 56e through a supply control valve 56d, and by controlling the opening and closing of the supply control valve 56d by a controller 100 (FIG. 1), supply of the water-soluble resin from the protective film resin supplying nozzle 56a is conducted. The oscillating arm 56 connected to a tip of a rotary support column 59a is oscillated by driving by a motor 56c, and the protective film resin supplying nozzle 56a is moved on an upper side of the wafer 11.

As illustrated in FIG. 2, a cleaning fluid supplying nozzle 57a is provided at a tip portion of another oscillating arm 57, and a cleaning fluid is supplied from the cleaning fluid supplying nozzle 57a. The cleaning fluid is a single liquid such as pure water, or a mixed fluid (binary fluid) obtained by mixing liquid such as pure water with gas.

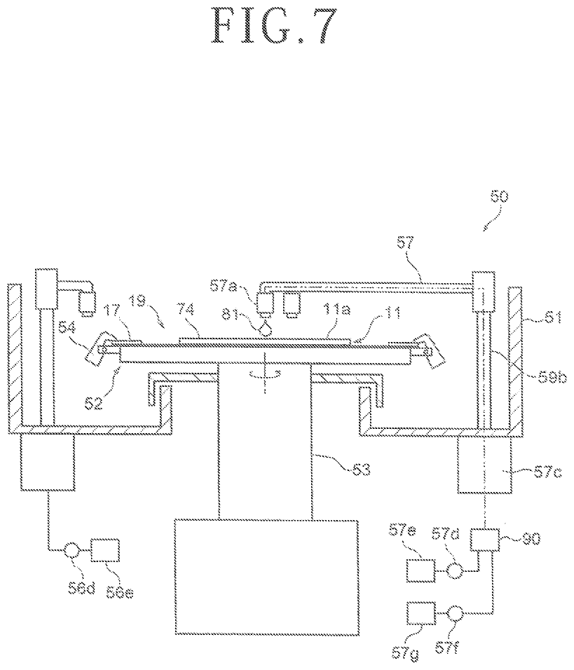

As depicted in FIG. 7, the cleaning fluid supplying nozzle 57a is connected to a pure water supply source 57e through a mixer 90 and a supply control valve 57d, and is further connected to a gas supply source 57g through the mixer 90 and a supply control valve 57f. The oscillating arm 57 connected to a tip of a rotary support column 59b is oscillated by driving by a motor 57c, and the cleaning fluid supplying nozzle 57a is moved on an upper side of the wafer 11.

When only the supply control valve 57d is opened by the controller 100 (FIG. 1), the mixer 90 permits only pure water to flow to the cleaning fluid supplying nozzle 57a. When the supply control valve 57d and the supply control valve 57f are opened by the controller 100 (FIG. 1), the mixer 90 mixes pure water with air, and the mixed fluid thus mixed is permitted to flow to the cleaning fluid supplying nozzle 57a. Note that the mode of mixing in the mixer 90 may be replaced by a mode of mixing in the cleaning fluid supplying nozzle 57a.

As illustrated in FIG. 2, a dry air supplying nozzle 58a is provided at a tip portion of a further oscillating arm 58, and dry air is supplied from the dry air supplying nozzle 58a. The dry air is a high-pressure gas such as air, and is used for removing a liquid adhering to the surface of the wafer 11 (FIG. 1).

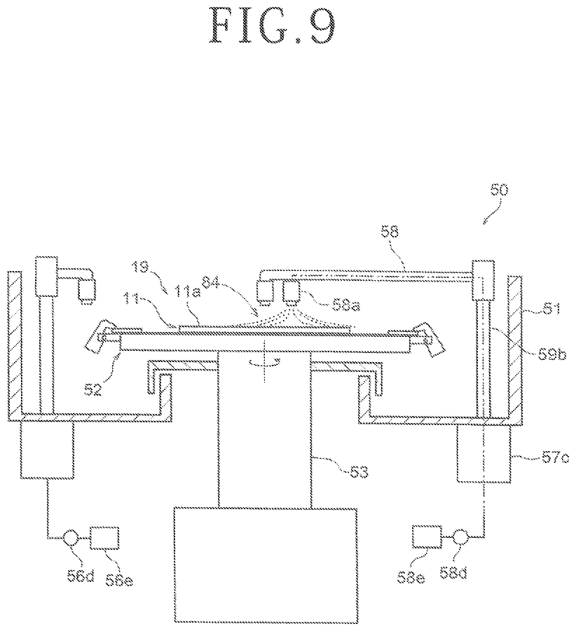

As depicted in FIG. 9, the dry air supplying nozzle 58a is connected to a gas supply source 58e that supplies a drying gas through a supply control valve 58d controlled by the controller 100 (FIG. 1). The oscillating arm 58 connected to a tip of a rotary support column 59b is oscillated by driving by a motor 57c, and the dry air supplying nozzle 58a is moved on an upper side of the wafer 11.

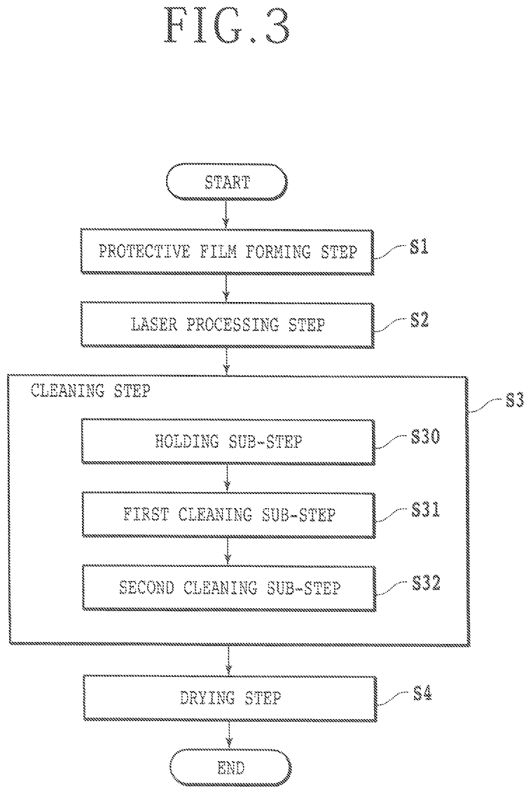

Next, an embodiment of a processing method using the above device configuration will be described. The present embodiment includes each of steps depicted in a flow chart of FIG. 3. Control of various kinds of operations described below is automatically controlled by the controller 100 that controls various mechanisms of the laser processing apparatus 2 depicted in FIG. 1.

### <Protective Film Forming Step S1>

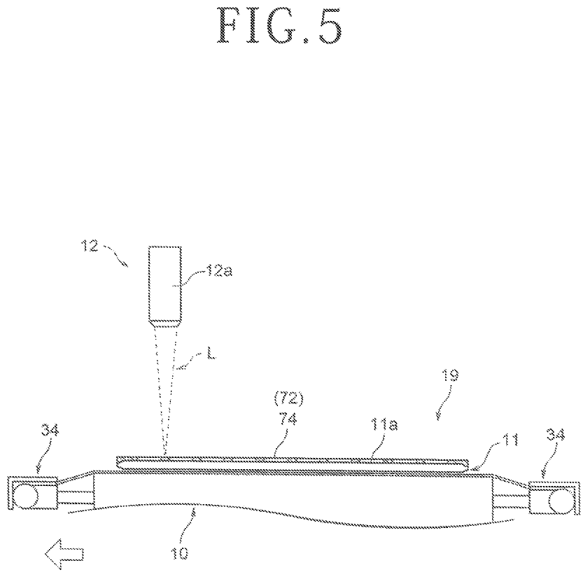

As illustrated in FIG. 4, this step is a step of coating an upper surface 11a of the wafer 11 with a protective film 74 (FIG. 5) including a water-soluble resin 72. Specifically, as depicted in FIG. 1, the wafer unit 19 is conveyed by an unillustrated conveying mechanism to the protective film applying and cleaning device 50, and is held by the spinner table 52. As illustrated in FIG. 4, the spinner table 52 is positioned at a predetermined height, and is spun at a predetermined spinning speed. While the motor 56c is driven to oscillate the oscillating arm 56, the water-soluble resin 72 is dropped onto the upper surface 11a of the wafer 11 from the protective film resin supplying nozzle 56a. By controlling the opening and closing of the supply control valve 56d, a predetermined amount of the water-soluble resin 72 is supplied to the protective film resin supplying nozzle 56a.

With the predetermined amount of the water-soluble resin 72 dropped from the protective film resin supplying nozzle 56a, the water-soluble resin 72 is distributed over the whole area of the upper surface 11a of the wafer 11. Next, the spinning of the spinner table 52 is stopped, and the water-soluble resin 72 is dried, whereby a protective film 74 (FIG. 5) is formed on the upper surface 11a of the wafer 11.

### <Laser Processing Step S2>

As depicted in FIG. 5, this step is a step of applying a laser beam L of such a wavelength as to be absorbed in the wafer 11 to the upper surface 11a, to perform ablation of the wafer 11. Specifically, as illustrated in FIG. 1, the conveying device 60 conveys the wafer unit 19 from the protective film applying and cleaning device 50 to the chuck table 10, and the chuck table 10 suction holds the wafer 11. The chuck table 10 is rotated and moved such that the street of the wafer 11 becomes parallel to the processing feeding direction, thereby performing alignment.

Then, as depicted in FIG. 5, while the chuck table 10 is put into processing feeding, the laser is applied from the processing head 12a of the laser beam applying unit 12 to the upper surface 11a of the wafer 11, whereby ablation for full-cutting (cutting) or grooving along the street is performed. The chuck table 10 is put into indexing feeding, to perform ablation of all the streets extending in a first direction, after which the chuck table 10 is rotated by 90 degrees, and ablation is conducted for all the streets extending in a second direction orthogonal to the first direction.

As illustrated in FIG. 5, the upper surface 11a of the wafer 11 is protected by being covered with the protective film 74, and, thus, debris (laser processing swarf) generated upon the ablation would not adhere directly to the upper surface 11a of the wafer 11.

### <Cleaning Step S3>

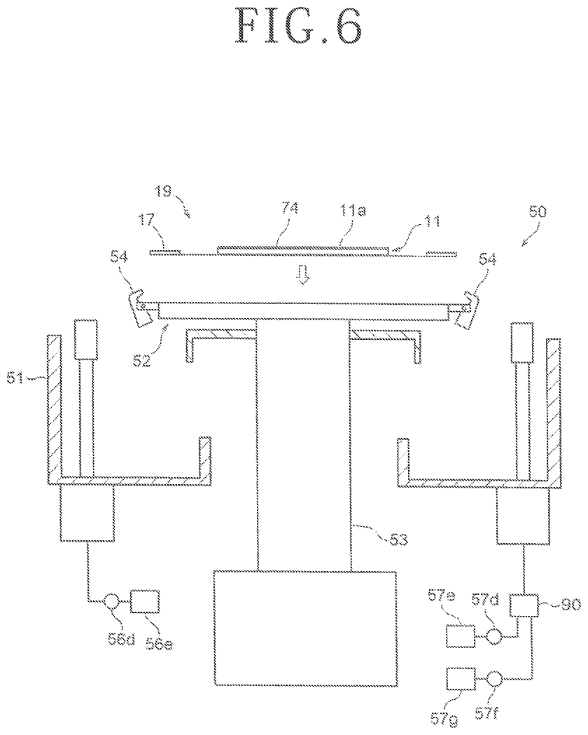

As illustrated in FIGS. 6 to 9, this step is a step of removing the protective film 74 (FIG. 5) from the upper surface 11a of the wafer 11 (FIG. 5) together with the debris generated in the laser processing step, after the laser processing step is carried out. As depicted in FIG. 3, the cleaning step S3 includes a holding sub-step S30, a first cleaning sub-step S31, and a second cleaning sub-step S32.

### <Holding Sub-Step S30>

As illustrated in FIG. 6, this step is a step of holding the wafer 11 by the spinner table 52 in a state in which the upper surface 11a of the wafer 11 coated with the protective film 74 is exposed. Specifically, the spinner table 52 is raised to a predetermined transfer position, and the wafer unit 19 conveyed by the conveying device 60 (FIG. 1) is mounted on the spinner table 52.

### <First Cleaning Sub-Step S31>

As depicted in FIG. 7, this step is a step of spinning the spinner table 52 holding the wafer 11 and supplying a cleaning fluid 81 to the upper surface 11a of the wafer 11. Specifically, the spinner table 52 is positioned at a predetermined height, and is spun at a predetermined spinning speed, and, while the motor 57c is driven to oscillate the oscillating arm 57, the cleaning fluid 81 is supplied from the cleaning fluid supplying nozzle 57a to the upper surface 11a of the wafer 11.

In this instance, the supply control valve 57d connected to the pure water supply source 57e is opened, and the supply control valve 57f connected to the gas supply source 57g is closed. As a result, only the cleaning fluid 81 (pure water) is supplied from the mixer 90 to the cleaning fluid supplying nozzle 57a. This first cleaning sub-step S31 is carried out for 20 to 30 seconds, for example, at a spinning speed of the spinner table 52 of 80 rpm and with the supply amount of the pure water of 200 ml/min.

In the first cleaning sub-step S31 described above, only the cleaning fluid 81 (pure water) not containing a high-pressure gas is supplied, and the protective film 74 is removed in the manner of being washed away. Thus, the dissolved protective film 74 is restrained from scattering to the surroundings, and the protective film 74 is prevented from adhering to wall surfaces of the internal space 51a (FIG. 1) of the housing 51, each of the nozzles 56a to 58a, or each of the arms 56 to 58.

### <Second Cleaning Sub-Step S32>

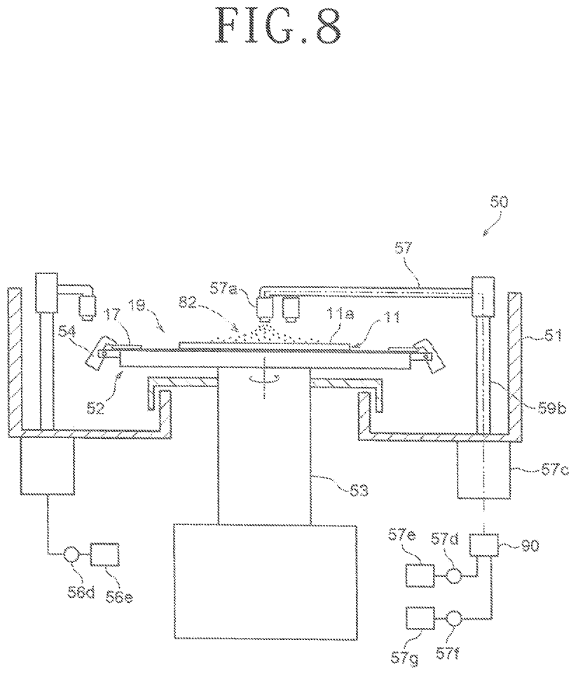

This step is a step of cleaning the wafer 11 by supplying the mixed fluid 82 obtained by mixing gas with a cleaning fluid to the upper surface 11a of the wafer 11 held by the spinning spinner table 52, as illustrated in FIG. 8, after the first cleaning sub-step S31 is carried out. Specifically, the spinner table 52 is positioned at a predetermined height, and is spun at a predetermined spinning speed, and, while the motor 57c is driven to oscillate the oscillating arm 57, the mixed fluid 82 is supplied from the cleaning fluid supplying nozzle 57a to the upper surface 11a of the wafer 11.

In this instance, the supply control valve 57d connected to the pure water supply source 57e and the supply control valve 57f connected to the gas supply source 57g are both opened, the cleaning fluid (pure water) and the gas (air) are supplied to the mixer 90, and the mixed fluid 82 is generated in the mixer 90. Then, the mixed fluid 82 (binary fluid) is supplied from the mixer 90 to the cleaning fluid supplying nozzle 57a.

This second cleaning sub-step S32 is carried out for 20 to 30 seconds, for example, at a spinning speed of the spinner table 52 of 800 rpm, with a supply amount of pure water of 200 ml/min, and at an air pressure of 0.4 MPa.

In the second cleaning sub-step S32 described above, the protective film 74 does not remain or remains only slightly, since the protective film 74 has preliminarily been removed in the first cleaning sub-step S31, so that, even when cleaning is conducted with the mixed fluid 82 (binary fluid) containing the high-pressure gas, the protective film 74 does not scatter or scatters only slightly.

### <Drying Step S4>

This step is a step of drying the wafer 11 by spinning the spinner table 52 at a speed higher than the spinning of the spinner table 52 in the cleaning step S3, as depicted in FIG. 9, after the above-mentioned series of cleaning step S3 is carried out. Specifically, the supply control valve 58d is opened to supply dry air 84 from the gas supply source 58e to the dry air supplying nozzle 58a, and the motor 57c is driven to oscillate the oscillating arm 58 by one reciprocation. In addition, simultaneously, the spinner table 52 is spun at a spinning speed of 2,000 rpm.

By this drying step S4, the liquid on the upper surface 11a of the wafer 11 is removed. Note that the supply of dry air 84 from the dry air supplying nozzle 58a may be omitted, and drying may be conducted by only the spinning of the spinner table 52. After the drying, the wafer unit 19 is conveyed from the protective film applying and cleaning device 50 by a conveying mechanism not illustrated.

In the first cleaning sub-step S31, only the cleaning fluid 81 (pure water) not containing a high-pressure gas is supplied, and the protective film 74 is removed in the manner of being washed away. Thus, the dissolved protective film 74 is restrained from scattering to the surroundings, and the protective film 74 can be prevented from adhering to wall surfaces of the internal space 51a (FIG. 1) of the housing 51, each of the nozzles 56a to 58, or each of the arms 56 to 58. In addition, in the second cleaning sub-step S32, the protective film 74 does not remain or remains only slightly, since the protective film 74 has preliminarily been removed in the first cleaning sub-step S31, so that, even when cleaning is conducted with the mixed fluid 82 (binary fluid) containing the high-pressure gas, the protective film 74 does not scatter or scatters only slightly.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A workpiece processing method comprising:
a protective film forming step of coating an upper surface of a workpiece with a protective film including a water-soluble resin;
a laser processing step of applying a laser beam of such a wavelength as to be absorbed in the workpiece to the upper surface to subject the workpiece to ablation, after the protective film forming step is carried out; and
a cleaning step of removing the protective film from the upper surface of the workpiece together with debris generated in the laser processing step, after the laser processing step is carried out,
wherein the cleaning step includes
a holding sub-step of holding the workpiece by a spinner table in a state in which the upper surface of the workpiece coated with the protective film is exposed,
a first cleaning sub-step of spinning the spinner table holding the workpiece and supplying a cleaning fluid to the upper surface of the workpiece, and
a second cleaning sub-step of supplying a mixed fluid of gas and the cleaning fluid to the upper surface of the workpiece held by the spinning spinner table, to clean the workpiece, after the first cleaning sub-step is carried out.

2. The workpiece processing method according to claim 1, further comprising:
a drying step of spinning the spinner table at a speed higher than the spinning of the spinner table in the cleaning step, after the cleaning step is carried out, to thereby dry the workpiece.
